(19) United States
(12) Patent Application Publication
(10) Pub. No.: US 2002/0128981 A1
(43) Pub. Date: Sep. 12, 2002

(54) Method and system for facilitating secure customer financial transactions over an open network

(76) Inventors: Joseph C. Kawan, Hollywood, CA (US); Lucien Dancanet, Los Angeles, CA (US)

Correspondence Address: George T. Marcou, Kilpatrick Stockton, LLP, Ste. 900, 607 14th Street, NW, Washington, DC, 20005, US

(21) Appl. No.: 10/034,427

(22) Filed: Dec. 27, 2001

Related U.S. Application Data
(60) Provisional application No. 60/258,304, filed on Dec. 28, 2000.

(51) Int. Cl. G06F 17/60

(52) U.S. Cl. 705/67

(57) ABSTRACT

A method and system for facilitating a secure financial transaction for a user over an open network eliminates a requirement for the customer's sensitive financial information, such as credit card or debit account information, to be provided to a merchant in a recognizable form in a transaction. Instead, the merchant provides the merchant's financial information to the customer's financial institution through the customer or directly. The customer either attaches instructions for payment to the merchant's information prior to forwarding it to the customer's financial institution or sends instructions for payment directly to the customer's financial institution. Alternatively, the customer's financial information passes through the merchant server on its way to the customer's financial institution but is transparent to the merchant.

### PRIORITY APPLICATION

This application claims the benefit of U.S. Provisional Application No. 60/258,304 filed Dec. 28, 2000 and entitled “METHOD AND SYSTEM FOR FACILITATING SECURE CUSTOMER FINANCIAL TRANSACTIONS OVER AN OPEN NETWORK,” incorporated herein by this reference.

### CROSS-REFERENCE TO RELATED APPLICATIONS

This application is related to U.S. Non-Provisional application Ser. No. 09/588,902 entitled “A METHOD AND SYSTEM FOR CONTROLLING CERTIFICATE BASED OPEN PAYMENT TRANSACTIONS,” incorporated herein by this reference.

### FIELD OF THE INVENTION

The invention relates generally to network-negotiated transactions and more particularly to financial institution involvement in network-negotiated transactions for a customer of the financial institution.

### BACKGROUND

Today, Internet transactions are being conducted by a larger and larger number of individuals with an ever increasing number of merchants. These transactions, often referred to in the industry as customer to business (“C to B”) transactions usually involve exchanging sensitive financial information over the Internet in order to facilitate a customer purchase from a merchant through the merchant's Website. This information more often than not includes credit card information, and in an increasing number of transactions, requires that financial institution and account information be exchanged. Most instances of pirating of private financial information occur as a result of weak security on the part of the merchants, as opposed to the other parties to Internet payment transactions. Unfortunately, current C to B Internet payment procedures require the customer to provide the merchant with at least some sensitive financial information, such as credit card number and expiration date. For example, a customer must choose a payment mechanism in order to make an Internet purchase. Currently, a number of credit card options are displayed and the customer is required to make a selection and provide type, number, and expiration information relevant to the selected credit card. This information is forwarded to the merchant who requests authorization for the amount of the transaction using the customer entered credit card information. Consequently, there is a need in the art for a more secure method and system for transacting over open networks such as the Internet.

Further, conventional C to B negotiations are initiated and perpetuated almost entirely through the efforts of the customer. In a typical situation, a customer establishes a connection with the Internet through a browser and proceeds to search, for example, through search engines such as Yahoo.com or through specific merchant sites, for various products and/or services the customer is interested in purchasing. As with conventional brick and mortar shopping, customers will have to “shop around” if they wish to compare prices on particular items. As such, although the Internet has put many choices at a customer's disposal and greatly improves C to B communication, it is still incumbent upon the customer to perform the searches, price shop, provide customer transaction information, and bear the risk of fraud for merchant security lapses. There is a need in the art for a less customer labor intensive method of performing cost-effective and secure C to B transactions which maintains customer control of the process and security of customer information.

### SUMMARY OF THE INVENTION

It is a feature and advantage of the present invention to provide a method and system for facilitating a secure financial transaction for a user over an open network that does not require that the customer's sensitive financial information, such as credit card or debit account information, be provided to the merchant in any remotely recognizable form in the course of completing the transaction.

It is another feature and advantage of the present invention to provide a method and system for facilitating a secure financial transaction for a user over an open network that assures that if the customer's financial information passes through the merchant server on its way to the customer's financial institution, the customer's financial information is transparent to the merchant.

It is an additional feature and advantage of the present invention to provide a method and system for facilitating a secure financial transaction for a user over an open network that enables the customer to further minimize the customer's involvement in the transaction process by, in addition to sending instructions for payment, also requesting that the financial institution search for, as well as purchase, products and/or services for the customer.

It is a further feature and advantage of the present invention to provide a method and system for facilitating a secure financial transaction for a user over an open network in which the customer's financial institution may perform other value added services after the customer provides instructions to the customer's financial institution to pay a customer-identified merchant for particular goods and/or services.

To achieve the stated and other features, advantages and objects of the present invention, in the preferred embodiments of the present invention, the facilitation of a C to B financial transaction does not require that the customer's sensitive financial information, such as credit card or debit account information, be provided to the merchant in any remotely recognizable form, in the course of completing the transaction. Instead, the merchant provides the merchant's financial information as well as the other transaction details to the customer's financial institution, either through the customer or directly. The customer either attaches instructions for payment to the merchant's information prior to forwarding the information to the customer's financial institution or sends the instructions for payment directly to the customer's financial institution. In the latter instance, the customer's financial institution matches the customer's instructions to the merchant-provided information. In either case, the merchant preferably does not receive any of the customer's financial information.

In a further embodiment, the customer's financial information does pass through the merchant server, on its way to the customer's financial institution, but the customer's financial information is transparent to the merchant. The customer's financial information is stored and transported in a secure format to the customer's financial institution. In another embodiment, in addition to sending instructions for payment, the customer is able to further minimize the customer's involvement in the transaction process, by requesting that the financial institution search for, as well as purchase, products and/or services for the customer. In an additional embodiment, after the customer provides instructions to the customer's financial institution to pay a customer-identified merchant for particular goods and/or services, the customer's financial institution may perform other value added services. For example, the customer's financial institution may offer to search for a better deal, such as a lower price, for the particular goods and/or services selected by the customer.

An embodiment of the present invention provides a method and system for facilitating a secure financial transaction for a user over an open network in which, for example, a payment preference profile for the user consisting at least in part of a designation of one or more user accounts for settlement of network transactions for the user is stored for the user on a customer payment options profile and authentication information database of a financial institution, such as the user's bank. The payment preference profile can include, for example, other preferences and rules for the user instructing the user's financial institution in handling network-negotiated transactions for the user, and/or a hierarchical order in which user accounts designated for settlement of network transactions for the user should be accessed for payment, and/or rules for each user account designated for settlement of network transactions for the user. The user can update the payment preference profile from time to time, for example, through one or more of the Internet through a designated financial institution website server, telephonically through a customer service representative, and/or through mail.

In an aspect of the invention, the user's financial institution receives a user-initiated request for settlement of a network transaction with a merchant. The user-initiated request can include payment settlement information received by the financial institution over the open network that is protected by a private key issued by the financial institution for electronic messages which the user intends to be viewed by the financial institution, and/or the user-initiated request can include payment settlement information protected by the private key in the form of software stored on a processor, such as a personal computer (PC), personal digital assistant (PDA), or a smart card, located at a remote site of the user. In one aspect of the invention, the user-initiated request can include the user's selection of an alternative payment option, in which a browser plug-in of the user's processor accesses the processor and formulates a secure electronic authorization/payment message and sends the message back through the browser plug-in to an electronic address for, for example, for a merchant server. However, the message passes securely through the merchant server to the deal closing server of the financial institution.

According to another aspect of the present invention, the financial institution accesses a customer authentication and authorization server in regard to the user according to identifying information for the user securely stored on a processor, such as the user's PC, PDA, and/or smart card, located at the remote site of the user. The identifying information for the user can be securely stored, for example, on the user's smart card processor by programming the processor by the financial institution when the payment preference profile is stored for the user. The customer authentication and authorization server accesses the user's payment preference profile on the customer payment options profile and authentication information database to identify the user account designated for settlement of network transactions for the user. A deal closing server of the financial institution initiates settlement of the network transaction with the designated account, if the user-initiated request for settlement is authenticated and authorized by the customer authentication and authorization server. Thereafter, the deal closing server notifies the merchant of payment and confirms completion of settlement of the network transaction to the user.

In another embodiment of the method and system of the present invention, a user-initiated search request for merchant information according to an entry by the user of user-specified parameters into field prompts on a web page of the user's financial institution together with user identification information is received by the financial institution. The user-initiated search request and user identification information can be protected, for example, with one or more of a private key, a digital signature, and a digital certificate issued to the user by the financial institution, and/or the user can logon the web page of the user's financial institution with user identification information consisting of one or more of a pre-selected password and a personal identification number in order to gain access to a search request web page. The financial institution authenticates the user based on the user identification information and sends the requested merchant information to the user, for example, via an e-mail and/or a message alert within a web page designated for the user upon successful user logon. In an aspect of such embodiment, the user can select an option from a group of negotiating/settlement options consisting, for example, of negotiating a network transaction by the user directly with the merchant according to the merchant information and settling with the merchant using a merchant-initiated payment request, negotiating by the user directly with the merchant according to the merchant information and settling with the merchant using a user-initiated payment request and payment preference profile stored on a database of the financial institution, and having the financial institution negotiate with the merchant according to the merchant information and settling with the merchant using the user-initiated payment request and payment preference profile.

In another embodiment of the method and system of the present invention, a user-initiated search request for merchant information according to an entry by the user of user-specified parameters into field prompts on a web page of the user's financial institution is received by the financial institution. The user-specified parameters can include, for example, a request for the financial institution to identify a merchant offering the best deal for the user, and the search request is protected with a security mechanism for authenticating the user. The user enters a selection on the financial institution's web page of an option for the financial institution to negotiate a network transaction with the identified merchant and to settle with the merchant based at least in part on the payment preference profile for the user stored on the customer payment options profile and authentication database. In such embodiment, the customer authentication and authorization server of the financial institution authenticates the user based on the security mechanism protecting the user-initiated search request and performs the user-initiated search request and identifies the merchant based at least in part on the pre-defined payment preference profile. In addition, the deal closing server of the financial institution checks a merchant verification server to confirm whether the identified merchant is in good standing. If the identified merchant is not in good standing according to the merchant verification server, the deal closing server can suggest an alternative merchant and offer the user options for the user to renegotiate direct with the alternative merchant or to have the financial institution renegotiate for the user with the alternative merchant. Further, the deal closing server can check a better deal server of the financial institution to verify that the best deal for the user is the deal with the identified merchant.

Additional objects, advantages and novel features of the invention will be set forth in part in the description which follows, and in part become more apparent to those skilled in the art upon examination of the following or may be learned by practice of the invention.

### BRIEF DESCRIPTION OF THE DRAWINGS

FIG. 1 shows an on overview of an example of key components and the flow of information between components for an embodiment of the present invention;

FIG. 2 is a flow chart that illustrates an example of the process of facilitating approval and initiating payment of the network-negotiated financial transaction such that the customer's sensitive payment information is accessible to the merchant for an embodiment of the present invention;

FIG. 3 is a flow chart that shows an example of the process of the financial institution providing the security mechanism for protecting the transfer of customer preference information for an embodiment of the present invention;

FIG. 4 is a schematic diagram of a customer-initiated payment process according to an alternate embodiment of the present invention;

FIG. 5 is a flow chart which shows an example of the process of the alternative payment option for an embodiment of the present invention;

FIG. 6 is a flow chart which illustrates an example of the process of the customer's financial institution searching for an appropriate merchant Website based on the product(s) and/or services request made by the customer;

FIG. 7 is a flow chart that shows an example of the process in which the financial institution does not to require the customer to send the information request with an attached security mechanism; and

FIG. 8 is a flow chart which illustrates an example of the network transaction process in which the customer delegates all of the network searching as well as the negotiation and settlement.

### DETAILED DESCRIPTION OF THE INVENTION

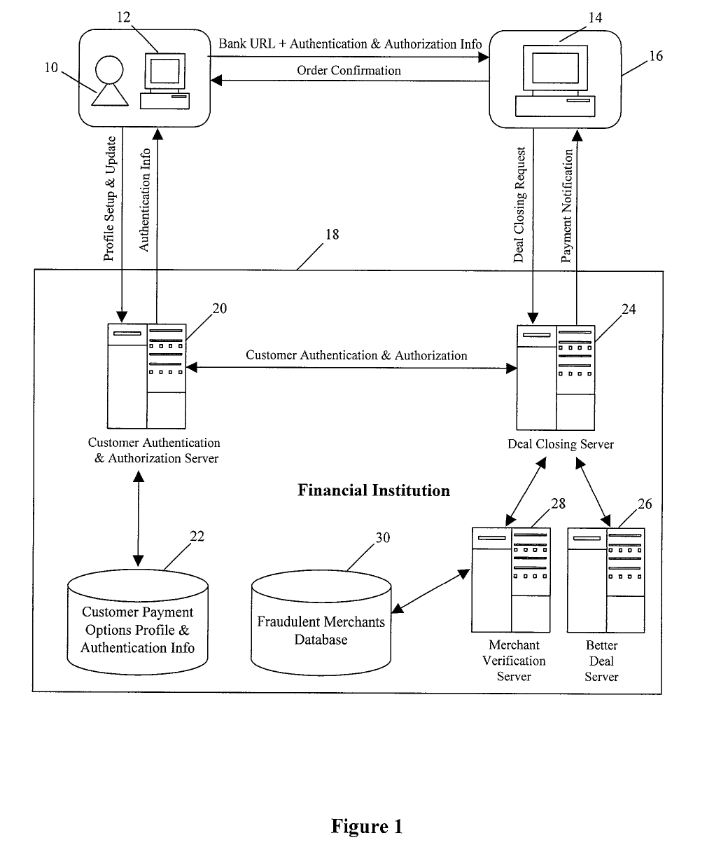

Referring now in detail to an embodiment of the present invention, an example of which is illustrated in the accompanying drawings, FIG. 1 shows an overview of an example of key components and the flow of information between key components for an embodiment of the present invention. Referring to FIG. 1, the system and method of the present invention makes use of computer hardware and software and includes, for example, a computing device 12 of a customer 10, such as a personal computer (“PC”), a personal digital assistant (“PDA”), or a smart card; the Website server 14 of a merchant 16; and one or more servers and/or databases of a financial institution 18, such as a customer authentication and authorization server 20 and customer payment options profile and authentication database 22, a deal closing server 24, a better deal server 26, and a merchant verification server 28 and fraudulent merchants database 30.

In a first embodiment of the present invention, the customer 10 elects to utilize a service offered by his/her financial institution 18, wherein the customer 10 is able to request that the customer's financial institution 18 bear the burden of facilitating payment of the customer's network C to B transactions. More particularly, a first embodiment of the present invention involves a process for facilitating approval and initiating payment of a network-negotiated financial transaction between the customer 10 and the merchant 16, such that the sensitive payment information of the customer 10 is never viewed by or accessible to the merchant 16.

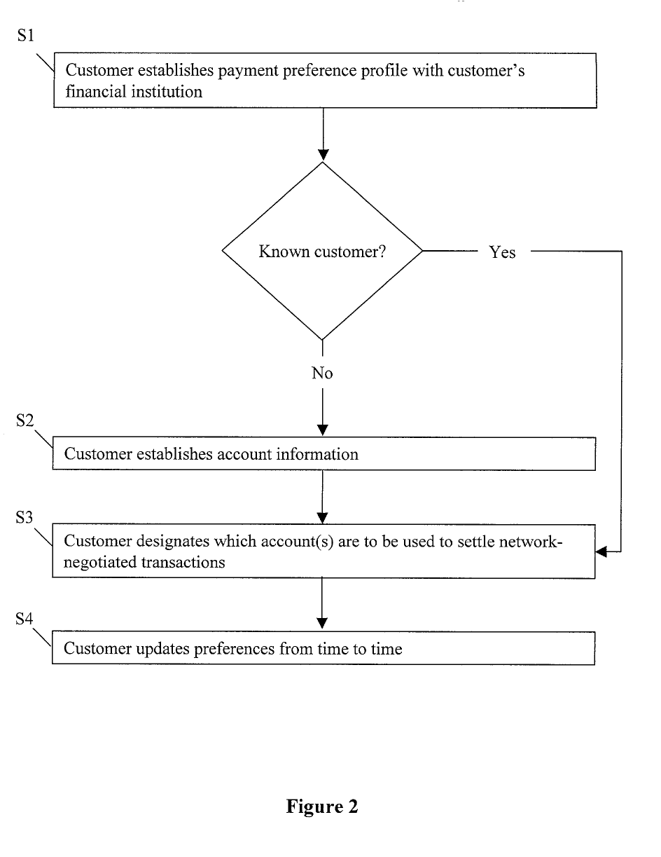

FIG. 2 is a flow chart that illustrates an example of the process of facilitating approval and initiating payment of the network-negotiated financial transaction in which the customer's sensitive payment information is not accessible to the merchant according to an embodiment of the present invention. Referring to FIGS. 1 and 2, in an initial step, S1, in this process, the customer 10 establishes a payment preference profile with the customer's financial institution 18. During the establishment of the payment preference profile, if the customer 10 is a first-time customer, at S2, the customer 10 establishes account information and, at S3, the customer 10 designates which of these new account(s) are to be used to settle network-negotiated transactions. In the case of a known customer, at S3, the customer 10 designates which established account(s) the customer 10 wishes to use to settle network-negotiated transactions. Once the customer 10 establishes a payment preference profile, at S4, the customer 10 can update preferences through any one of a variety of means, including but not limited to the Internet through a designated financial institution Website, telephonically through a customer service representative, or through the mail.

Further, as discussed below, in an alternative embodiment, in addition to the designation of accounts by the customer 10 at S3 as shown in FIG. 2, the customer's payment preference profile contains other preferences or rules for instructing the customer's financial institution in handling network-negotiated transactions. For example, the customer 10 can designate the order in which the settlement account(s) should be accessed for payment, such as settlement account (1) credit card, settlement account (2) checking account, and settlement account (3) brokerage account. In this alternative embodiment, the customer 10 is also able to establish rules for each account. Such rules can include, for example, “Only settle with settlement account (2) if the available balance for settlement account (1) does not cover the payment amount” or “Every settlement account must maintain a minimum or available balance of a predetermined dollar amount, so move to settlement account (2) if settling with settlement account (1) will violate this rule.”

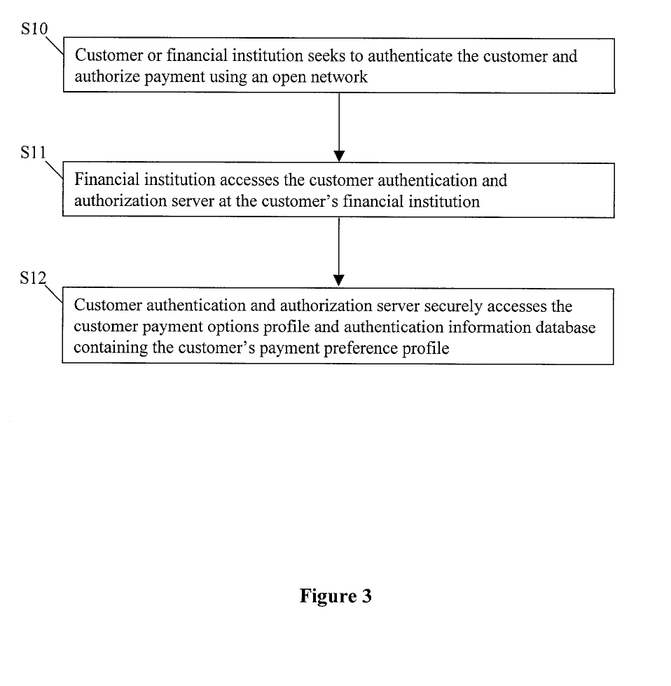

In addition to designating account(s) and account rules within the payment preference profile, the financial institution 18 provides the customer 10 with a security mechanism for protecting the transfer of customer preference information. FIG. 3 is a flow chart that shows an example of the process of the financial institution 18 providing the security mechanism for protecting the transfer of customer preference information for an embodiment of the present invention. Referring to FIG. 3, when the customer 10 or the financial institution 18 seeks to authenticate the customer 10 and authorize payment using an open network at S10, the financial institution 18 accesses the customer authentication and authorization server 20 at the customer's financial institution 18 at S11, which securely accesses the customer payment options profile and authentication information database 22 containing the customer's payment preference profile at S12.

In virtually all instances, the customer 10 will be negotiating the C to B transaction remotely, over an open network, such as the Internet. Consequently, the customer 10 must send payment settlement information over the open network. In at least one embodiment, in order to protect the payment information, the customer 10 attaches a private key issued by his/her financial institution 18 to all electronic messages which the customer 10 intends to be viewed by the financial institution 18. This private key locks the information, such that it is only readable by the customer's financial institution 18. This private key is in the form of software stored on a processor located at the remote site of the customer 10. This processor is usually stored on the computing device 12, such as the customer's PC, PDA, smart card, or the like.

Additionally, in order for the financial institution 18 to recognize which payment preference profile should be accessed, at least some identifying information is preferably also securely stored within the customer's processor 12. A smart card is an ideal mechanism for use in this situation, as smart cards are easily programmed by the customer's financial institution 18 at the time the customer 10 establishes the payment preference profile. Consequently, the customer's financial institution 18 provides the customer 10 with a private key, and/or other authentication, such as digital certificates and/or digital signatures, and authorization information after the customer 10 establishes his/her payment preference profile as shown in FIG. 2.

Further to the first embodiment, after a customer negotiates a network transaction with a merchant, e.g., selects products and/or services for purchase on a merchant Website, the customer selects a payment method. Conventionally, as discussed above, selection of a payment method entails selecting from a variety of credit card types, entering the credit card number, and entering the credit card expiration date into the required fields as prompted. This information forms a payment authorization request which goes through the merchant payment processor, over an established credit authorization network to a credit card authorization server. The credit authorization server verifies the information provided by the customer and sends the results of the verification back to the merchant. The merchant than proceeds to either confirm receipt of authorization with the customer or deny the transaction due to lack of verification.

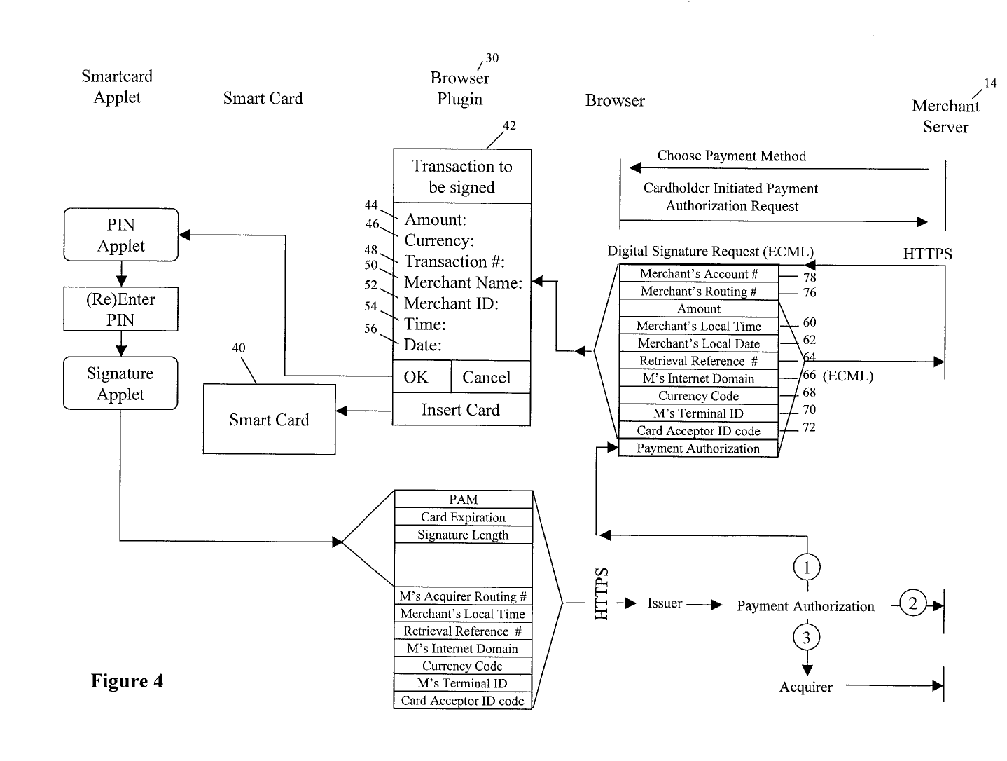

According to a first embodiment of the present invention, the merchant Website 14 offers an alternative payment option. FIG. 4 is a schematic diagram of a customer-initiated payment process according to an alternate payment option for an embodiment of the present invention. The alternative payment option, when selected by the customer 10 who has established a payment preference profile, allows the customer 10, as opposed to the merchant 16, to initiate the payment request. Further, the customer's payment information is not entered by the customer 10 and is transparent to the merchant 16 during authorization. Instead, when the customer 10 selects the alternative payment option, the customer's processor 12 retrieves the customer's identifying information (e.g., from smart card 40) and attaches this information to the transaction information 42 resulting from the network negotiation forming an electronic authorization/payment message as shown in FIG. 4.

The transaction information 42 shown in FIG. 4 includes, for example, amount 44, currency 46, transaction number 48, merchant name 50, merchant identification information 52, and/or time 54 and date 56 of the transaction. The merchant identification information 52 shown in FIG. 4, which is gleaned from the merchant server 14, for example, includes merchant's local time 60, merchant's local date 62, retrieval reference number 64, merchant's universal resource locator (“URL”) or other address information 66, currency code 68, merchant's terminal identification 70, and/or card acceptor identification code 72. In certain embodiments, the transaction information 42 contains merchant settlement information, including information about merchant's financial institution 76 and merchant account preferences 78. In a more specific embodiment, the merchant's financial institution is the same as the customer's financial institution 18.

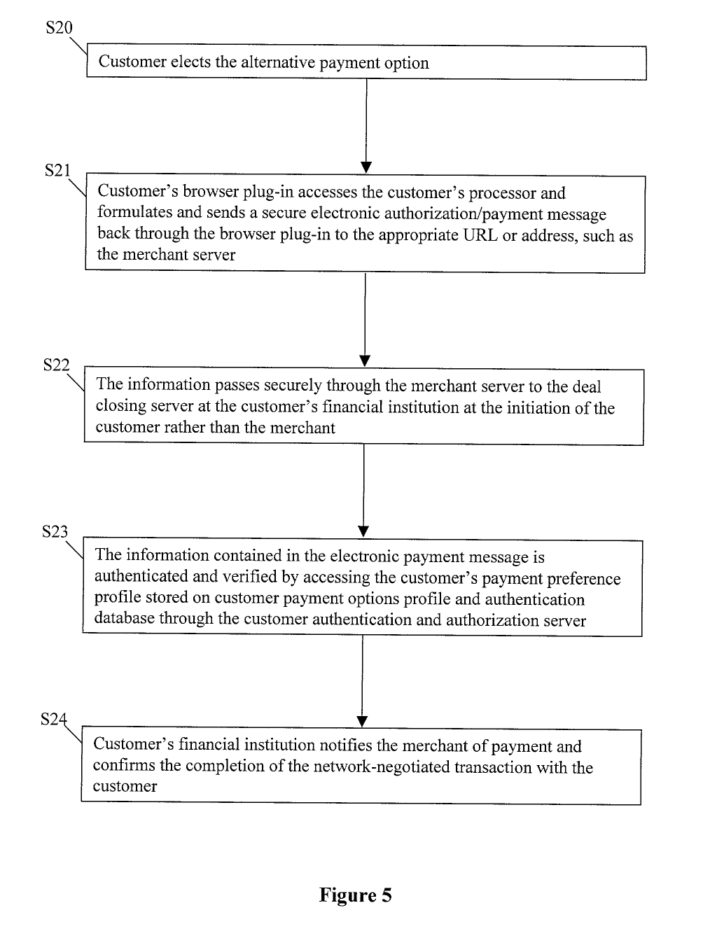

FIG. 5 is a flow chart which shows an example of the process of the alternative payment option for an embodiment of the present invention. The processor, such as smart card 40, contains a URL or similar address information, such as dial-up instructions, which is retrieved from the processor 40 in order to send the electronic authorization/payment message 42 to the appropriate location, such as servers at the customer's financial institution 18 and/or merchant's financial institution. Consequently, referring to FIG. 5, at S20, when the customer 10 elects the alternative payment option, at S21, the customer's browser plug-in 80 accesses the customer's processor, such as smart card 40, and formulates a secure electronic authorization/payment message 42 and sends the message 42 back through the browser plug-in 80 to the appropriate URL or address, such as the merchant server 14. Using this payment option, the customer 10 initiates the authorization and payment of a network-negotiated transaction instead of the merchant 16. Further, the customer's payment information 42 does not need to pass through the merchant 16 where it could potentially be subject to fraud by hackers or by dishonest merchants.

Referring further to FIG. 5, at S22, the information passes securely through the merchant server 14 to the deal closing server 24 at the customer's financial institution 18, but at the initiation of the customer 10 not the merchant 16. Once received by the deal closing server 24 at the customer's financial institution 18, at S23, the information contained in the electronic payment message 42 is authenticated and verified, by accessing the customer's payment preference profile stored on customer payment options profile and authentication database 22 through the customer authentication and authorization server 20. Once the customer-initiated request has been authenticated and authorized, at S24, the customer's financial institution 18 notifies the merchant 16 of payment and confirms the completion of the network-negotiated transaction with the customer 10.

In a second embodiment of the present invention, the customer 10 is able to delegate network searching and information gathering responsibilities to the customer's financial institution 18. In such second embodiment, the customer's financial institution 18 offers value-added services to the customer 10 by locating product(s) and/or services based on a customer-defined request. These services include searching for customer-requested products and/or services based on customer-supplied information, such as book title, author, or VIN number. In this second embodiment, the customer 10 never accesses the Website 14 of the merchant 16. Instead, the customer 10 instructs the customer's financial institution 18 to search for and find an appropriate merchant Website based on the product(s) and/or services request made by the customer 10. The customer 10 may request that the search be performed based on any number of criteria including product type, manufacturer, product commercial name, lowest price, best value, financial institution recommendation, and/or the like.

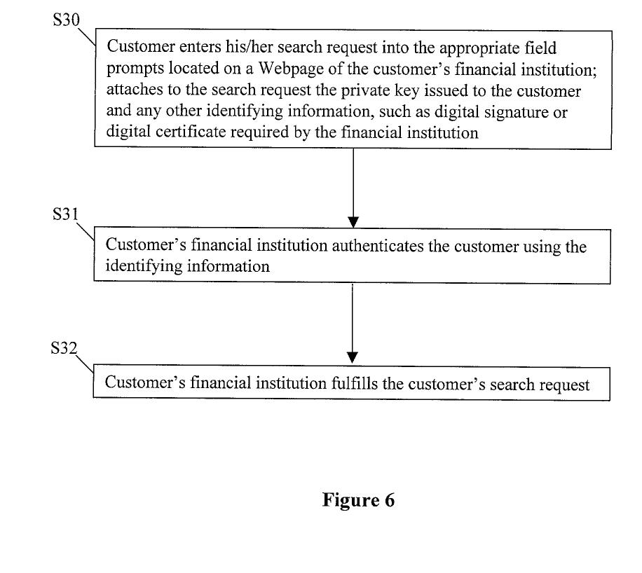

FIG. 6 is a flow chart which illustrates an example of the process of the customer's financial institution 18 searching for an appropriate merchant Website based on the product(s) and/or services request made by the customer 10. Referring to FIG. 6, in this second embodiment, at S30, the customer 10 enters his/her search request into the appropriate field prompts located on a Web page of the customer's financial institution 18. The financial institution 18 may require that the customer 10 attach to this search request the private key issued to the customer 10 and any other identifying information such as a digital signature or a digital certificate. Using this information, at S31, the customer's financial institution 18 is able to authenticate the customer 10 before fulfilling the customer's search request at S32, thus avoiding customer fraud. In this embodiment, the customer 10 is not required to have established a payment preference profile as in the first embodiment.

Further, in an embodiment in which the customer 10 requests information from the customer's financial institution 18 but does not request that the financial institution 18 perform a negotiation for the customer 10, the financial institution 18 may choose not to require the customer 10 to send the information request with an attached security mechanism, such as the private key, digital signature, and/or digital certificate. Instead, the customer 10 may be able to send the information request by logging into an appropriate Web page at the customer's financial institution 18 and entering the request into the data field prompts.

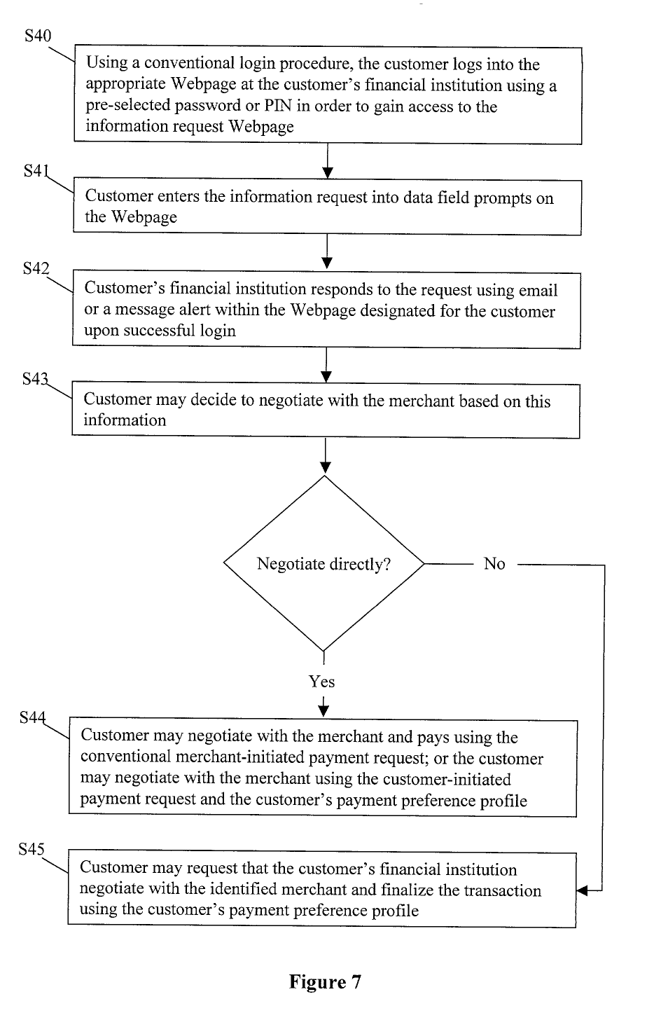

FIG. 7 is a flow chart that shows an example of the process in which the financial institution does not to require the customer to send the information request with an attached security mechanism. Referring to FIG. 7, in this embodiment, the login procedure is a conventional procedure, in which the customer 10 logs into the appropriate Web page at the customer's financial institution 18 using a pre-selected password or PIN in order to gain access to the information request Web page at S40. At S41, the customer 10 enters the information request into data field prompts on the Web page. At 42, the customer's financial institution 18 responds to the request using, for example, e-mail or a message alert within the Web page designated for the customer 10 upon successful login.

In this embodiment, referring further to FIG. 7, once the customer 10 receives the requested information, at S43, the customer 10 may decide to negotiate with a particular merchant based on this information. Depending on the customer's relationship with the customer's financial institution 18, at S44, the customer 10 may negotiate with the merchant 16 and pay using the conventional merchant-initiated payment request, or the customer 10 may negotiate with the merchant 16 using the customer-initiated payment request and the customer's payment preference profile discussed with reference to the first embodiment. Alternatively, at S45, the customer 10 may request that the customer's financial institution 18 negotiate with the identified merchant 16 and finalize the transaction using the customer's payment preference profile.

In a third embodiment of the present invention, the customer 10 delegates all of the network searching as well as the negotiation and settlement of a network transaction to the customer's financial institution 18. The customer 10 instructs the customer's financial institution 18 to (a) fulfill an information request, i.e., search for and locate the customer requested products and/or services and (b) negotiate and settle the negotiated transaction using the customer's payment preference profile. In this third embodiment, the financial institution 18 need not respond to the customer's request for information prior to commencing with the merchant negotiations, as the customer 10 has already instructed the customer's financial institution 18 to negotiate based on the information that the financial institution 18 finds.

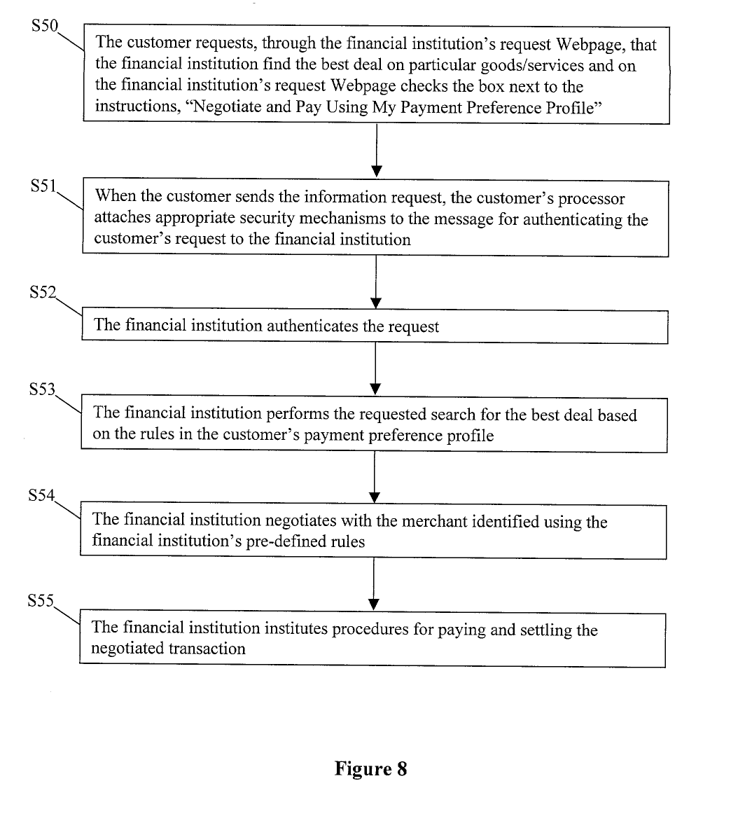

FIG. 8 is a flow chart which illustrates an example of the network transaction process in which the customer 10 delegates all of the network searching as well as the negotiation and settlement. Referring to FIG. 8, by way of example, at S50, the customer 10 of the financial institution 18 requests, through the financial institution's request Web page, that the financial institution 18 find the best deal on goods or services, such as a particular brand of television. On the financial institution's request Web page, the customer 10 checks the box next to the instructions, “Negotiate and Pay using My Payment Preference Profile.” At S51, when the customer 10 sends the information request, the customer's processor attaches appropriate security mechanisms to the message for authenticating the customer's request to the financial institution 18. At S52, the financial institution 18 authenticates the request; at S53, the financial institution 18 performs the requested search for the television based on the rules in the customer's payment preference profile; at S54, the financial institution 18 negotiates with the merchant 16 found using the financial institution's pre-defined rules; and at S55, the financial institution 18 institutes procedures for paying and settling the negotiated transaction. In this example, the customer's involvement in the transaction is minimized and the customer's request and transaction information is secured using one of multiple security mechanisms. An additional benefit resulting from this implementation of the second embodiment is the increased protection of the customer's individual preferences, resulting in a decline in the number of unwanted solicitations which could result if the merchant 16 were privy to the customer's purchasing information.

In a fourth embodiment of the present invention, the customer 10 performs part of the network negotiation, but requests that the customer's financial institution 18 do final checks on the details of the negotiation prior to instituting payment proceedings. For example, these final checks can include comparing the merchant 16 in the transaction to a pre-established and regularly updated database of fraudulent merchants and comparing the negotiated price for product(s) and/or services to a pre-established and regularly updated database of prices for similar product(s) and/or services. Referring again to FIG. 1 as an example, after the customer-initiated electronic payment message is received at the financial institution's deal closing server 24, it is authenticated and authorized through the merchant verification server 28.

Further, pursuant to this fourth embodiment, the customer's financial institution 18 checks other servers, such as the merchant verification server 28 and the better deal server 26, to confirm the standing of the merchant 16 listed in the electronic payment transaction 42 and to verify that the customer 10 is getting the best deal on the customer-requested product(s) and/or services. These servers may be updated through internal databases, such as the fraudulent merchants database 30, and/or other networks, such as the Internet, and databases, such as credit bureaus. Further, the customer 10 may request that if the merchant 16 does appear on the fraudulent merchant database 30, that the financial institution 18 either (a) suggest an alternative merchant who deals in the product(s) and/or services that the customer 10 wishes to purchase, and allow the customer 10 to renegotiate with the alternative merchant or (b) find an alternative merchant and perform the negotiations for the customer 10, as discussed in the third embodiment in which the customer 10 delegates all of the network searching as well as the negotiation and settlement to the financial institution 18, and as illustrated, for example, in FIG. 8.

Further to the all embodiments, the customer's financial institution 18 is also able to offer the customer 10 special incentives to utilize the financial institution 18 for instituting and negotiating network transactions. For example, the customer's financial institution 18 may procure discounts from merchants whom the customer's financial institution 18 agrees to recommend to its customers. This discount is based on factors such as volume of sales and advertising time. The customer's financial institution 18 passes these discounts on to the customers when they agree to purchase product(s) and/or services from these merchants through the use of the customer's payment preference profile. The customer's financial institution 18 is also able to offer percentage discounts to those customers who agree to pay for network transactions using a particular form of account, such as debit (e.g., checking accounts) as opposed to credit accounts. In the instances where the customer 10 elects to pay using a debit account, the customer's financial institution 18 can also negotiate a merchant performance guarantee.

Various preferred embodiments of the invention have been described in fulfillment of the various objects of the invention. It should be recognized that these embodiments are merely illustrative of the principles of the present invention. Numerous modifications and adaptations thereof will be readily apparent to those skilled in the art without departing from the spirit and scope of the present invention. Accordingly, the invention is only limited by the following claims.

What is claimed is:

1. A method for facilitating a secure financial transaction for a user over an open network, comprising:
storing a payment preference profile for the user consisting at least in part of a designation of at least one user account for settlement of network transactions for the user on a customer payment options profile and authentication information database of a financial institution;
receiving a user-initiated request by the financial institution for settlement of a network transaction with a merchant;
accessing a customer authentication and authorization server by the financial institution in regard to the user;
securely accessing the user's payment preference profile on the customer payment options profile and authentication information database by the customer authentication and authorization server to identify the user account designated for settlement of network transactions for the user;
initiating settlement of the network transaction with the designated account by a deal closing server of the financial institution, if the user-initiated request for settlement is authenticated and authorized by the customer authentication and authorization server; and
notifying the merchant of payment and confirming completion of settlement of the network transaction to the user by the deal closing server.

2. The method of claim 1, wherein storing the payment preference profile for the user further comprises storing other preferences and rules for the user instructing the user's financial institution in handling network-negotiated transactions for the user.

3. The method of claim 2, wherein storing other preferences and rules for the user further comprises storing a hierarchical order in which user accounts designated for settlement of network transactions for the user should be accessed for payment.

4. The method of claim 2, wherein storing other preferences and rules for the user further comprises storing rules for each user account designated for settlement of network transactions for the user.

5. The method of claim 1, wherein storing the payment preference profile for the user further comprises allowing the user to update the payment preference profile through at least one of the Internet through a designated financial institution website server, telephonically through a customer service representative, and through mail.

6. The method of claim 1, wherein receiving the user-initiated request by the financial institution further comprises receiving payment settlement information over the open network from the user protected by a private key issued by the financial institution for electronic messages which the user intends to be viewed by the financial institution.

7. The method of claim 6, wherein receiving the payment settlement information over the open network further comprises receiving the payment settlement information from the user protected by the private key in the form of software stored on a processor located at a remote site of the user, wherein the processor comprises one of a personal computer, a personal digital assistant, and a smart card.

8. The method of claim 1, wherein receiving the user-initiated request by the financial institution further comprises allowing the user to select an alternative payment option.

9. The method of claim 8, wherein receiving the user-initiated request by the financial institution further comprises allowing a browser plug-in of a processor of the user to access the processor and formulate a secure electronic authorization/payment message and send the message back through the browser plug-in to an electronic address for a merchant server.

10. The method of claim 9, wherein sending the message back through the browser plug-in to the merchant server further comprises passing the message securely through the merchant server to the deal closing server of the financial institution.

11. The method of claim 1, wherein accessing the customer authentication and authorization server by the financial institution further comprises accessing the customer authentication and authorization server by the financial institution according to identifying information for the user securely stored on a processor located at a remote site of the user, wherein the processor comprises one of a personal computer, a personal digital assistant, and a smart card.

12. The method of claim 11, wherein accessing the customer authentication and authorization server by the financial institution according to the identifying information further comprises accessing the customer authentication and authorization server according to the identifying information for the user securely stored on the user's smart card processor that was programmed by the financial institution when the payment preference profile was stored for the user.

13. A method for facilitating a secure financial transaction for a user over an open network, comprising:
receiving a user-initiated search request for merchant information according to an entry by the user of user-specified parameters into field prompts on a web page of the user's financial institution together with user identification information;
authenticating the user by the financial institution based on the user identification information;
sending the requested merchant information to the user by the financial institution via one of an e-mail and a message alert within a web page designated for the user upon successful user login; and
allowing the user to select an option from a group of negotiating/settlement options consisting of negotiating a network transaction by the user directly with the merchant according to the merchant information and settling with the merchant using a merchant-initiated payment request, negotiating by the user directly with the merchant according to the merchant information and settling with the merchant using a user-initiated payment request and payment preference profile stored on a database of the financial institution, and having the financial institution negotiate with the merchant according to the merchant information and settling with the merchant using the user-initiated payment request and payment preference profile.

14. The method of claim 13, wherein receiving the user-initiated search request further comprises receiving the search request and user identification information protected with at least one of a private key, a digital signature, and a digital certificate issued to the user by the financial institution.

15. The method of claim 13, wherein receiving the user-initiated search request further comprises allowing the user to logon the web page of the user's financial institution with user identification information consisting of at least one of a pre-selected password and a personal identification number in order to gain access to a search request web page.

16. A method for facilitating a secure financial transaction for a user over an open network, comprising:
receiving a user-initiated search request for merchant information according to an entry by the user of user-specified parameters into field prompts on a web page of the user's financial institution, wherein the user-specified parameters comprise at least a request for the financial institution to identify a merchant offering a best deal, and wherein the search request is protected with a security mechanism for authenticating the user;
receiving the user's selection on the financial institution's web page of an option for the financial institution to negotiate a network transaction with the identified merchant and to settle with the merchant based at least in part on a payment preference profile for the user stored on a customer payment options profile and authentication database of the financial institution;
authenticating the user by a customer authentication and authorization server of the financial institution based on the security mechanism protecting the user-initiated search request; and
performing the user-initiated search request and identifying the merchant based at least in part on the pre-defined payment preference profile stored for the user on the customer payment options profile and authentication database of the financial institution.

17. The method of claim 16, wherein performing the search request and identifying the merchant further comprises checking a merchant verification server to confirm whether the identified merchant is in good standing.

18. The method of claim 17, wherein checking the merchant verification server further comprises suggesting an alternative merchant and offering the user one of an option for the user to renegotiate direct with the alternative merchant and an option to have the financial institution renegotiate for the user with the alternative merchant, if the identified merchant is not in good standing according to the merchant verification server.

19. The method of claim 16, wherein performing the search request and identifying the merchant further comprises checking a better deal server of the financial institution to verify a best deal with the identified merchant for the user.

20. A system for facilitating a secure financial transaction for a user over an open network, comprising:
a customer payment options profile and authentication information database of a financial institution storing a payment preference profile for a user consisting at least in part of a designation of at least one user account for settlement of network transactions for the user;
a deal closing server of the financial institution for receiving a user-initiated request by the financial institution for settlement of a network transaction with a merchant; and
a customer authentication and authorization server of the financial institution accessible by the deal closing server for securely accessing the user's payment preference profile on the customer payment options profile and authentication information database to identify the user account designated for settlement of network transactions for the user, wherein the deal closing server is adapted to initiate settlement of the network transaction with the designated account, if the user-initiated request for settlement is authenticated and authorized by the customer authentication and authorization server, and wherein the deal closing server is further adapted to notify the merchant of payment and confirm completion of settlement of the network transaction to the user.

21. A system for facilitating a secure financial transaction for a user over an open network, comprising:
a customer authentication and authorization server of a financial institution for receiving a user-initiated search request for merchant information according to entry by the user of user-specified parameters into field prompts on a web page of the user's financial institution together with user identification information, wherein the customer authentication and authorization server is adapted for authenticating the user based on the user identification information; and
a deal closing server for sending the requested merchant information to the user via the customer authentication and authorization server by one of an e-mail and a message alert within a web page designated for the user upon successful user logon, and wherein the deal closing server is adapted for receiving a selection of the user of an option from a group of negotiating/settlement options consisting of on option of negotiating a network transaction by the user directly with the merchant according to the merchant information and settling with the merchant using a merchant-initiated payment request, an option of negotiating by the user directly with the merchant according to the merchant information and settling with the merchant using a user-initiated payment request and payment preference profile stored on a database of the financial institution, and an option of having the financial institution negotiate with the merchant according to the merchant information and settling with the merchant using the user-initiated payment request and payment preference profile.

22. A system for facilitating a secure financial transaction for a user over an open network, comprising:
a financial institution customer authentication and authorization server for receiving a user-initiated search request for merchant information according to an entry by the user of user-specified parameters into field prompts on a web page of the user's financial institution, wherein the user-specified parameters comprise at least a request for the financial institution to identify a merchant offering a best deal, wherein the search request is protected with a security mechanism for authenticating the user;
a deal closing server of the financial institution for receiving the user's selection on the financial institution's web page of an option for the financial institution to negotiate a network transaction with the identified merchant offering and to settle with the merchant base at least in part on a payment preference profile for the user stored on a customer payment options profile and authentication database of the financial institution;
wherein the customer authentication and authorization server is adapted for authenticating the user based on the security mechanism protecting the user-initiated search request; and
wherein the deal closing server is adapted to perform the user-initiated search request and identify the merchant offering the best deal based at least on part on the pre-defined payment preference profile stored for the user on the customer payment options profile and authentication database.

23. The system of claim 22, farther comprising a merchant verification server and associated fraudulent merchants database coupled to the deal closing server for confirming whether the identified merchant is in good standing.

24. The system of claim 22, further comprising a better deal server coupled to the deal closing server for verifying the best deal with the identified merchant for the user.
